(19) United States
(12) Patent Application Publication
(10) Pub. No.: US 2025/0033883 A1
(43) Pub. Date: Jan. 30, 2025

(54) SHUTTLE ELEVATOR FOR SHELF SYSTEM, SHELF SYSTEM, AND METHOD FOR DISPLACING A SHUTTLE

(71) Applicant: Rocket Solution GmbH, Waechtersbach (DE)

(72) Inventors: Florian VENT, Hohenbrunn (DE); Tobias WEBER, Kalbach (DE); André NOWINSKI, Forchheim (DE)

(73) Assignee: Rocket Solution GmbH, Waechtersbach (DE)

(21) Appl. No.: 18/913,155

(22) Filed: Oct. 11, 2024

Related U.S. Application Data
(63) Continuation of application No. PCT/EP2023/058110, filed on Mar. 29, 2023.

(30) Foreign Application Priority Data
Apr. 11, 2022 (DE) 10 2022 108 761.1
Apr. 11, 2022 (DE) 20 2022 101 942.8

(51) Int. Cl. B65G 1/06

(52) U.S. Cl. CPC B65G 1/065

(57) ABSTRACT

A shuttle elevator for a shelf system with at least one shuttle and at least two levels for storing load carriers. The shuttle elevator comprises a displacement unit. A shelf system with a shuttle elevator is also provided. A method is also provided for moving a shuttle with a shuttle elevator from one level to a further level of a shelf system, in which there is a displacement of the shuttle from its travel position, a displacement of the shuttle to another level of the shelf system, and displacement of the shuttle to its travel position.

This nonprovisional application is a continuation of International Application No. PCT/EP2023/058110, which was filed on Mar. 29, 2023, and which claims priority to German Patent Application No. 10 2022 108 761.1, which was filed in Germany on Apr. 11, 2022, and to German Patent Application No. 20 2022 101 942.8, which was filed in Germany on Apr. 11, 2022, and which are all herein incorporated by reference.

### BACKGROUND OF THE INVENTION

### Field of the Invention

The invention relates to a shuttle elevator for a shelf system, in particular for a warehouse shuttle system for small load carriers, to a shelf system and to a method for moving a shuttle from one level to a further level of the shelf system.

### Description of the Background Art

In automated warehouse technology in the subarea of small load carriers, i.e., with load carriers with a maximum dimension of 400×600 mm and a maximum weight of 50 kg, the load carriers, which are often designed as crates, are usually transported by a shuttle system in a shelf system, which is therefore also referred to as a warehouse shuttle system. The shelf system comprises several shelves arranged next to each other, each of which usually comprises several levels. Between each two shelves there are aisles for at least one shuttle. The latter transports the load carriers to a shelf compartment of the shelf assigned by the logistics system and deposits them there or removes a load carrier from a shelf compartment and transports it to a picking area. This is usually arranged at a front side of the shelf and has at least one transfer point per shelf system on each level and one or more elevators that transport the load carriers to the different shelf levels.

During storage, the load carriers are fed to the shelf system via conveyor technology on a feeding level, which is designed on the corresponding floor of a hall, for example, and are picked up by the elevator with a load handling device and moved to the predetermined shelf level. There, the load carrier is in turn transferred by the elevator to a transfer point, which can be equipped with driven and/or non-driven rollers or with supports. From the transfer point, the load carrier is picked up by the shuttle with the help of the load handling device of the shuttle and then transported by the latter to the assigned shelf compartment. There, the shuttle is positioned to the shelf compartment and the load carrier is stored in the shelf compartment.

The shelf systems can be designed in such a way that not every level of the shelf system has a shuttle available, but one shuttle is used on different levels as needed. The shuttle is moved from one level to another by so-called shuttle elevators, which are also arranged on one of the front sides of the shelf system. Usually, the elevator for the load carriers is arranged at one front side of the shelf system and the shuttle elevator is located on the opposite front side. This is disadvantageous because this arrangement leads to very long travel distances for the shuttle from its last load carrier displacement on one level to the shuttle elevator and then back to the load carrier elevator. If, for example, a shuttle is positioned at the transfer point to unload a load carrier at the front side of the shelf system used for storage and retrieval, said load carrier must cover the entire length of the shelf to the other front side of the shelf system before it can be moved to a further level by the shuttle elevator located there. There are also shuttle elevators integrated into the lift for the load carriers, but these have the disadvantage that load carriers and shuttle can only be transported together. This severely limits the flexibility and thus the storage capacity of the shelf system, i.e., the number of load carriers stored or retrieved per time.

### SUMMARY OF THE INVENTION

It is therefore an object of the present invention to provide a shuttle elevator and a shelf system which remedy the disadvantages existing in the prior art. A further object of the invention is to provide a method for the rapid displacement of a shuttle from one level to a further level of the shelf system.

A shuttle elevator according to an example of the invention for a shelf system with at least one shuttle and at least two levels for storing load carriers is characterized in that the shuttle elevator comprises a displacement unit. The displacement unit is set up to move the shuttle from its travel position. The travel position of the shuttle is defined in the sense of the application in such a way that the shuttle is arranged on a predetermined level of the shelf system in the shelf and is ready to move on this level, i.e., can be controlled by the overall control system of the shelf system for retrieval or storage of a load carrier on the level. The travel position is therefore arranged in the aisle of the shelf from which the load carriers can be stored or removed from the shelf.

In particular, the displacement unit may be designed to shift the shuttle horizontally to the direction of travel of the shuttle. In this context, horizontal can mean on the level of the shelf in which the shuttle is currently located or at least temporarily parallel to the plane. In contrast to the displacement with a shuttle elevator known from the state of the art. This picks up the shuttle at the end of the shelf by moving the shuttle up and then shifts it up or down to a further level, i.e., perpendicular to the level of the shelf in the sense of the definition.

Furthermore, the shuttle elevator can be set up to lift the shuttle off its running rail. For this purpose, the displacement unit can be connected to the shuttle, with the help of which the shuttle elevator can lift the shuttle off the running rail. By the horizontal displacement, the shuttle can be shifted from the running rail into the shuttle elevator according to the invention.

In addition, the shuttle elevator may be designed to lift a partial rail of a shuttle running rail with the shuttle arranged on this partial rail.

In particular, the displacement unit may be designed to displace the partial rail of the running rail with the shuttle arranged on the partial rail. The displacement unit can be moved under the running rail and the shuttle and accommodate the shuttle and the partial rails on a displacement platform. The shuttle elevator connected to the displacement unit can lift the displacement unit with the displaced platform and its running rail and the shuttle arranged thereon. The displacement unit can then move the partial rail and the shuttle across the running rail, which is arranged in an aisle between two shelves of the shelf system, to the area of a shelf, i.e., to the part of the shelf system in which the load carriers can also be stored.

The displacement unit may comprise a lifting device. The lifting device can perform the function of lifting the displacement unit with the partial rail arranged on the displacement platform and the shuttle arranged on it. This has the advantage that the shuttle elevator need only move to one position so that the shuttle (with the partial rail) can be picked up.

In particular, the displacement unit may comprise at least one locking mechanism.

The locking mechanism can lock the shuttle, a displacement unit of the shuttle and the partial rail, which prevents the components from slipping when the shuttle is moved. The locking mechanism can be formed by pins or bolts, which are arranged on the displacement platform and engage in corresponding recesses in the displacement unit, the partial rail and the shuttle.

A shelf system according to the invention comprises a shuttle elevator according to an example described above.

Furthermore, the shelf system can include a running rail with a removable partial rail. As explained above, the partial rail can be moved by the shuttle elevator with the shuttle arranged on the partial rail.

In addition, the running rail can include connecting elements to mechanically connect the partial rail to the running rail.

The connecting elements can be passively designed. The partial rail can be inserted into the running rail, which has corresponding slopes, with the help of slopes formed on both sides. If the shuttle accelerates or brakes on the partial rail, the forcing acting on the partial rail in this case can lead to the partial rail slipping in relation to the running rail along the slope. This slipping can be advantageously prevented by the connecting elements, which are designed as cones or pins and a corresponding recess or fitting hole, for example, by blocking the movement of the partial rail in the direction of travel.

Furthermore, the connecting elements can also be actively designed. The connecting elements, such as pins or bolts, can be operated by actuators, simple solenoid switches or pneumatically, for example, and actively connect the partial rail fitted into the running rail.

In particular, the running rail can include a plug connection to electrically connect the partial rail to the running rail. The running rail, which is energized via a busbar to supply the shuttle drive, is separated by removing the partial rail. The plug connection, which can be designed with a plug on the partial rail and with a socket on the running rail, for example, allows for the busbar to be easily connected. Ideally, the guide for aligning the partial rail with the running rail is designed in such a way that the plug and the socket are aligned with each other with sufficient precision that they are automatically joined when the partial rail is inserted into the running rail.

The shuttle elevator can be arranged within a shelf for storing load carriers of the shelf system. The shelf is the area of the shelf system in which the load carriers can be stored in shelf compartments. In contrast, there are areas which are arranged at the front or rear of the shelf system, in which the load carriers are conveyed by conveyor systems to the warehouse shuttle system or from the warehouse shuttle system, i.e., they represent the interface of the warehouse shuttle system to the entire warehouse.

Usually, the elevators for moving the load carriers are arranged on different levels of the shelf system in this interface area, while the shuttle elevators used to replace or move the shuttles to further levels are arranged on the opposite side of the shelf. The advantage of having the arrangement of the shuttle elevator within the storage area of the shelf is that by placing the elevator in the middle of the storage area, the distance for a shuttle to the shuttle elevator is shorter as compared to using a shuttle elevator attached to the front sides of the shelf. This results in a shorter displacement time for a shuttle from one level of the shelf system to a further level of the shelf system. In addition, with the same floor space of the shelf system, more space can be used to store load carriers, which further increases the storage density.

A method according to the invention for moving a shuttle with a shuttle elevator from one level to a further level of a shelf system comprises the following method steps: displacement of the shuttle from its travel position, displacement of the shuttle to a further level of the shelf system, and displacement of the shuttle to its travel position.

The travel position has already been defined.

In particular, the movement of the shuttle from its travel position may involve a translational movement. As mentioned above, this can include a horizontal movement to the direction of travel.

Furthermore, the movement of the shuttle from its travel position can include a rotational movement. A rotational movement, for example, can be useful if a deflection of the displacement unit caused by the weight of the shuttle when it is lifted is to be maintained in order to prevent the shuttle from slipping off the displacement unit. It is also conceivable to at least partially minimize the stroke for lifting the partial rail out of the running rail by means of a rotational movement.

The movement of the shuttle from its travel position may comprise two translational movements executed perpendicular to each other. These can include, for example, lifting the shuttle off the running rails, possibly also lifting the shuttle with the partial rails from the running rails and a subsequent horizontal movement to the direction of travel. The rotational motion already explained above can also be combined with the two translational movements.

Furthermore, the movement of the shuttle to a further level of the shelf system can be carried out within the shelf of the shelf system. The advantages of this method have already been explained above.

In addition, the movement of the shuttle into the travel position of the shuttle can correspond to the movements from the travel position in reverse order.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a shelf system known from the state of the art,

FIG. 2 shows a schematic representation of a shelf system according to the invention,

FIG. 3 shows a schematic representation of a shelf system according to the invention in a sectional representation to describe a method according to the invention,

FIGS. 4a, 4b show a schematic detail representation of a shuttle elevator according to the invention,

FIG. 5 shows detailed representation of a running rail of the shelf system,

FIG. 6 shows a further detailed representation of the running rail of the shelf system,

FIG. 7 shows a further detailed representation of the running rail of the shelf system, and

FIG. 8 shows a flowchart to a method according to the invention.

### DETAILED DESCRIPTION

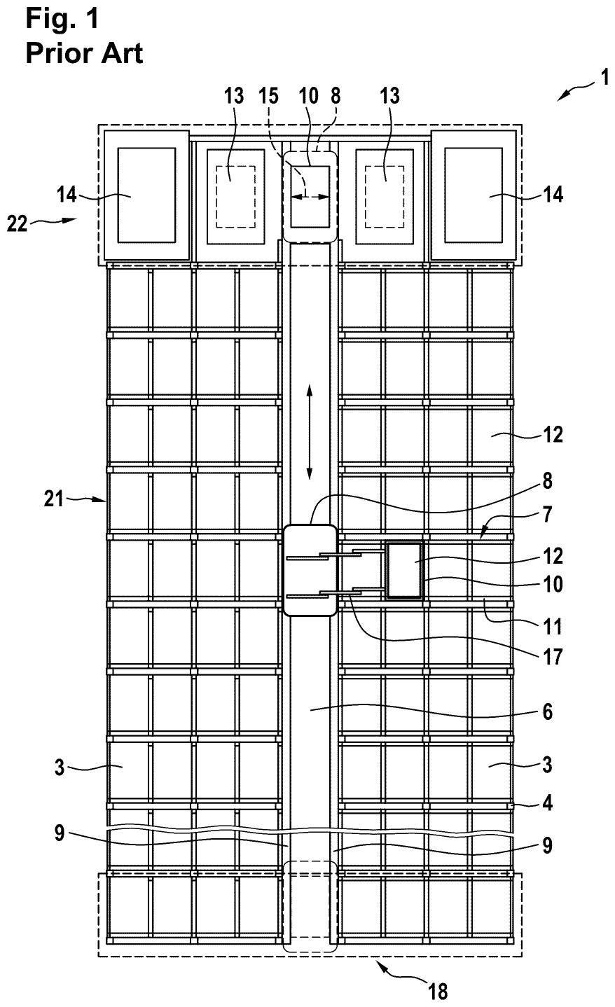

FIG. 1 shows a top view of a section of a level 21 of a shelf system for small load carriers known from the state of the art and formed as a warehouse shuttle system 1 in which two shelves 3 of a shelf system 1 are shown. Small load carriers 12 usually have a floor area of 400×600 millimeters and a maximum weight of 50 kg, with a maximum height of 600 millimeters and are also referred to as load carriers in the following. Between the two shelves 3 is an aisle 6 with a running rail 9, which is connected to risers 4 of the two adjacent shelves 3. A shuttle 8 with a load handling device 10 transports a load carrier 12, which is designed as a crate in the example shown, along the aisle 6. In a picking area 22 arranged at the upper front side of the shelves 3 shown in FIG. 1, elevators 14, which transport the load carriers 12 to the individual levels 21 of the shelves 3, transfer the load carriers 12 to a picking station 13, which can be driven or non-driven. From the picking station 13, the load handling device 10 takes the load carrier 12 with the help of the displacement unit 15 and transports it to a shelf compartment 7 in the shelves 3 intended for storage. The movement of the shuttle 8 in the aisle 6 is illustrated in the figure with a double arrow. The load carrier 12 is stored in the shelf compartment 7 by the load handling device 10 at one of the four possible positions in the example shown. For this purpose, the displacement unit 15 comprises a lifting device for lifting the load carrier 12, and a horizontal drive designed as a telescopic drive 17. The load handling device 10, including the lifting device, is pushed into the shelf compartment 7 by the telescopic drive 17 on load-bearing profiles 11, which are arranged on each side of the shelf compartment 7 on the risers 4. The load carrier 12 is lifted by the lifting device in such a way that it hovers above the load-bearing profiles 11 at a distance of 1 mm to 25 mm. At the predetermined position in the shelf compartment 7, the load carrier 12 is lowered by the lifting device so that it can come to rest on the load-bearing profiles 11. In the example shown, the load-bearing profiles 11 are designed in such a way that they are used both as a rail for the load handling device 10 and as a support for the load carrier 12. Alternatively, the rail for the load handling device 10 and the support for the load carrier 12 can also be designed as two separate components. At the opposite lower front of the aisle 6 of the shelf system 1 shown in FIG. 1, a shuttle elevator 18 is formed, which can move the shuttle 8 from the level 21 of the shelf system 1 shown in FIG. 1 to a further level of the shelf system 1. In addition, the shuttle elevator 18 can also be used to move the shuttle 8 in the event that the shuttle 8 needs maintenance or fails. The example of the shelf system 1 shown in FIG. 1 has a smaller number of shuttles 8 than levels in the shelf system 1, so that the shuttle elevator 18 is used to move the shuttle 8 between the levels of the shelf system 1. By moving the shuttle 8 between the levels of the shelf system 1, all levels can be used. The number of shuttles 8 can be determined depending on the required storage capacity, i.e., the number of load carriers stored or retrieved 12, and the costs for the shelf system 1.

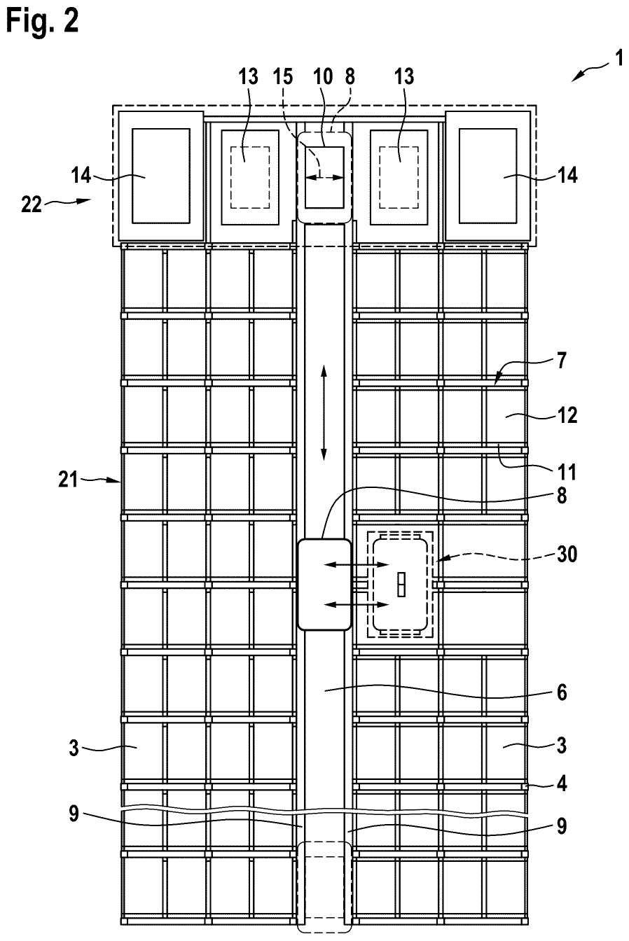

FIG. 2 shows a schematic representation of a shelf system embodied as a warehouse shuttle system 1 according to the invention, with a shuttle elevator 30 arranged in the shelf 3 of the shelf system 1, wherein the picking area 22 of the shelf system 1 is identical to the area described in FIG. 1. The shuttle elevator 30 according to the invention is disposed within the shelf 3, i.e., within the area intended for storage of the load carriers 12. The arrangement of the shuttle elevator 30 in the shelf 3 leads to an advantageous saving of installation space, since only the installation space of one of the two shelves 3 of the shelf system 1 is required for the shuttle elevator 30. The shuttle elevator 18 shown in FIG. 1, which is located at the lower front side, can thus be omitted, which can mean that more storage spaces for load carriers 12 can be created using the same floor space of the shelf system 1.

The arrangement of the shuttle elevator 30 in the middle of the shelf 3 shown in FIG. 2 also has the advantage that the paths for the shuttle 8 are shortened as compared to the arrangement shown in FIG. 1, in particular after the removal of a load carrier 12. As a result, the time required to move a shuttle 8 from one level to a further can be effectively reduced, increasing the time in which the shuttle 8 is available to move load carriers 12.

Compared to an integrated shuttle elevator 18 as described in FIG. 1, the additional shuttle elevator 30 has the advantage that the displacement of the shuttle 8 and the load carrier 12 can be performed independently of each other, which can advantageously optimize the storage performance of the warehouse shuttle system 1. The shuttle elevator 30 includes a displacement unit, which shifts the shuttle 8 sideways from its travel position. The travel position is the position from which the shuttle 8 can be moved in the aisle 6 or in which the shuttle 8 can store or retrieve a load carrier 12 from a picking station 13 or a shelf compartment 7, i.e., the travel position is the position in which the shuttle 8 is ready for operation.

The shuttle elevator 30 then moves the shuttle 8 to a level assigned by the logistics system. Once the desired level is reached, the shuttle 8 is returned to its travel position by the displacement unit on the rail 9 of the shelf system 1 and is therefore ready for operation on the new level.

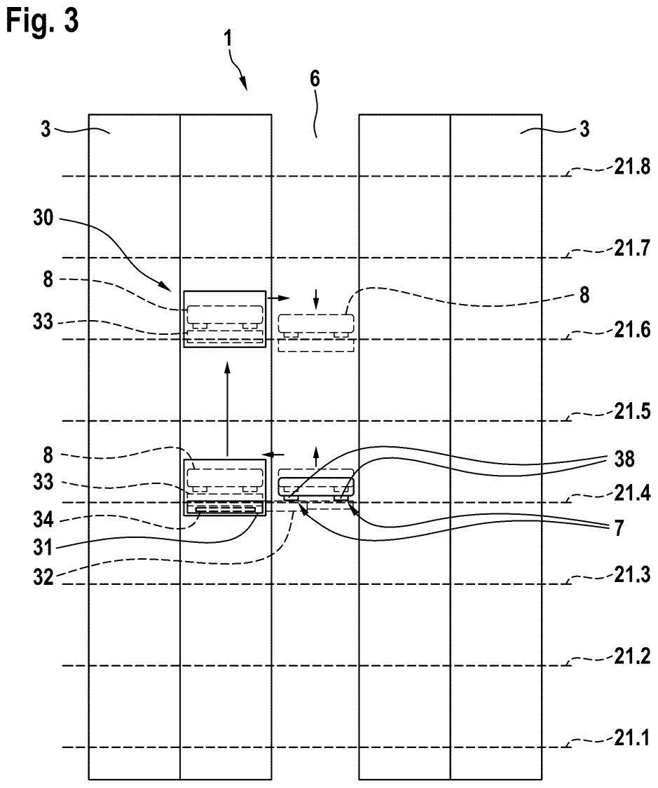

FIG. 3 shows a schematic representation of a shelf system 1 according to the invention in a sectional representation with eight levels 21.x. The shuttle 8 is arranged on level 21.4 and is to be moved to level 21.6. The shuttle elevator 30 is moved to level 21.4 and positioned to take over the shuttle 8. To pick up the shuttle 8, the displacement unit 32 moves a displacement platform 33 under the shuttle 8 and the running rail 9. In the example described in FIG. 3, the shuttle 8 is lifted on a removable partial rail 38 of the running rail 9, i.e., together with the partial rail 38. Lifting the displacement platform 33 is effected by the shuttle elevator 30, wherein an additional lifting device 34 is also conceivable, which is shown in FIG. 3 in dashed lines. The optional lifting device 34, as well as the displacement unit 32, are located in an elevator container 31, which is used to pick up the shuttle 8 and the partial rail 38 during the displacement from level 21.4 to level 21.6. The elevator container 31 has a floor on which the lifting device 34 and the displacement unit 32 are arranged. A belt is attached to the bottom of the floor to drive the shuttle elevator 30. The floor is connected to a lid of the elevator container 31 via side parts, which absorbs the weight of the elevator container 31 and the shuttle 8 with the partial rail 38. The lid is also connected to a second end of the belt. The elevator container 31 is open in the direction of the running rails 9, so that the displacement platform 33 can be extended to move the shuttle 8 with the partial rail 38 into the elevator container 31. The displacement unit 32 is designed to be tilted in relation to the elevator container 31 in order to compensate for the deflection of the displacement platform 33 caused by the leverage effect and the weight of the shuttle 8. The displacement platform 33 is therefore not aligned parallel to the running rail 9 when unloaded, but at a slight angle that compensates for the deflection caused by the weight of the shuttle 8. As a result, the lifting and insertion of the partial rail 38 is effected at the same time for both running rails 9, advantageously avoiding tilting or jamming of the partial rail 38 with the running rail 9.

Alternatively, only the shuttle 8 can be lifted from the running rail 9, wherein all components that may prevent the shuttle 8 from lifting off the running rail 9, such as current collectors, must be moved. After being lifted, the displacement platform 33 with the shuttle 8 on the partial rail 38 is retracted into the elevator container 31 and the shuttle elevator 30 moves to the destination level 21.6. On level 21.6, the shuttle 8 with the partial rails 38 is reinserted into the running rail 9 by the displacement unit 32. The partial rail 38 can be moved together with the shuttle 8 as usually only one shuttle 8 per level 21.x is inserted since it is not possible for two shuttles 8 to approach the picking area 22 of the load carriers 12 at the front side of the shelf system 1 within one aisle 6. If there is more than one shuttle 8 in an aisle 6, they move only in certain areas of the aisle 6 so as to avoid collisions, so in this case a shuttle elevator 30 can be set up for each area. If a shuttle 8 is removed from an area of the aisle 6, no other shuttle 8 will continue to serve this area, so that the absence of the partial rail 38 is not a problem.

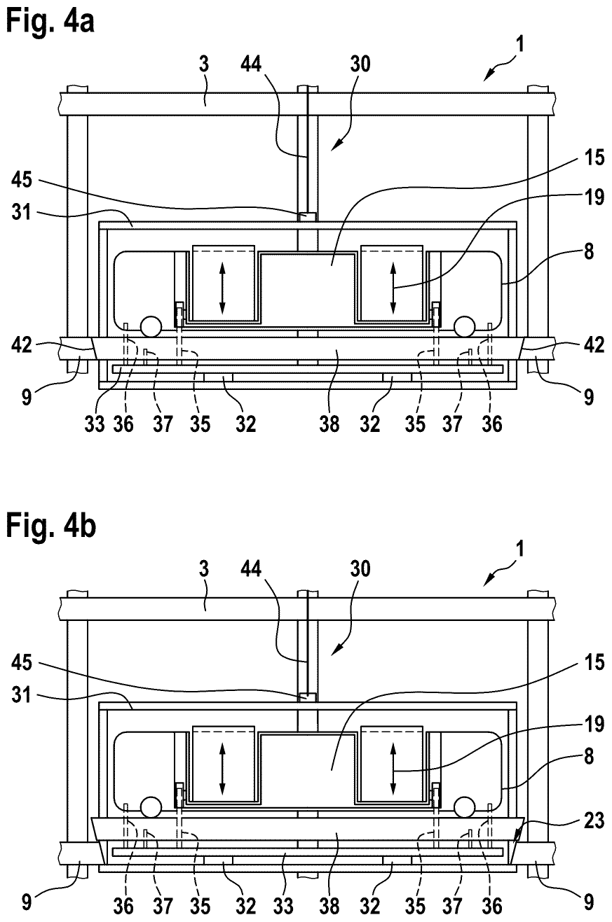

FIG. 4a shows a schematic detail representation of a shuttle elevator 30 according to the invention in a sectional representation in which a shuttle 8 is shown before it is lifted. The displacement platform 33 is already connected to the shuttle 8 and the partial rail 38. The connection is effected by locking mechanisms 35, 36, 37, which are formed as pins and whose purpose is to prevent a lateral movement or a slipping of the shuttle 8, the displacement unit 15 located on the shuttle 8, or the partial rail 38 on the displacement platform 33 during the displacement of the shuttle 8. The lifting device 19, which is also arranged on the shuttle 8, does not need to be additionally secured in the example described in FIG. 4a. Depending on the design of the shuttle 8, other components of the shuttle 8 can be locked. Alternatively, the connection between the displacement platform 33 and the shuttle 8 and the partial rails 38, as well as the locking 35, 36, 37 of the displacement unit 15 of the shuttle 8 can also be realized by two diagonally disposed locking mechanisms designed as pins below the displacement unit 15. The partial rail 38 is separated at an interface 42 of the running rail 9, which will be explained in more detail using FIG. 6. The elevator container 31 is connected to a belt 44 of the shuttle elevator 30 via a belt fixation 45. The belt 44 is guided over several pulleys and is attached to a second belt fixation on the underside of the elevator container 31. The belt 44 is connected to a drive.

FIG. 4b shows the shuttle 8, which is lifted by the shuttle elevator 30 with the partial rail 38. The lifting is effected by a displacement of the shuttle elevator 30 and lifts the partial rail 38 with the shuttle 8 to such an extent that when the displacement platform 33 is moved into the elevator container 31, the partial rail 38 can be moved by the displacement unit 32 above the running rail 9, which is firmly connected to the shelf 3. Once the displacement platform 33 is completely driven in, the shuttle elevator 30 can move the shuttle 8 to a further level 21.x, where the partial rail 38 is reinserted into the corresponding recess in the running rail 9.

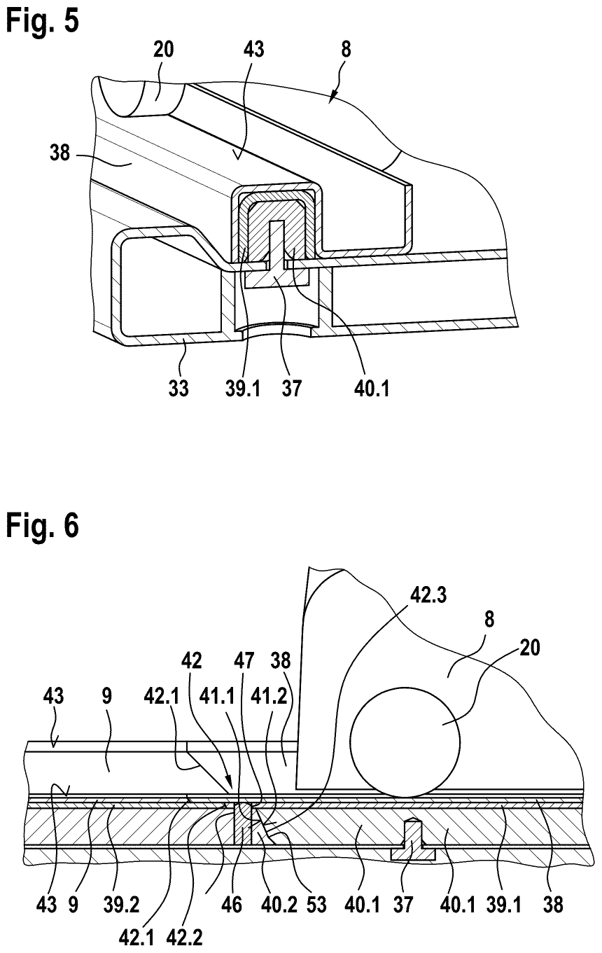

FIG. 5 shows a detailed representation of the partial rail 38 in a cross-sectional view. In the example shown, a reinforcing element 39.1 and a filling 40.1 are used to stiffen the partial rail 38. The reinforcing element 39.1 is designed to correspond to the U-shaped partial rail 38 and is in turn filled with the filling 40.1. The filling 40.1 serves on the one hand to reinforce and on the other hand also to accommodate the locking mechanism 37 described in FIG. 4a. The partial rail 9 has an identical reinforcement in the area of the interface 42.

FIG. 6 shows a further detailed representation of the running rail 9 with the partial rail 38 in the area of the interface 42 in a cross-sectional view. The interface 42 is divided into three interfaces 42.1, 42.2, 42.3 by the reinforcement described in FIG. 5. The interfaces 42.1, 42.2, 42.3 between the individual elements of the reinforced area around the interface 42, i.e., the running rail 9 and the partial rail 38, the reinforcing element 39.1 and reinforcing element 39.2 and filling 40.1 and filling 40.2 are offset in such a way that they overlap. The interface 42.1 is thus designed in such a way that the end of the partial rail 38 rests on the reinforcing element 39.2 of the running rail 9 described in FIG. 5 and that the flanks of the U-shaped partial rail 38 encloses the flanks of the likewise U-shaped reinforcing element 39.2. The reinforcing element 39.1 of the partial rail 38, in turn, rests on the filling 40.2 of the running rail 9 in some areas and encloses it. The filling 40.1 of the partial rail 38, with its front side inclined at an angle of less than 90° to the direction of travel 41.1, comes into contact with the corresponding inclined front side 41.2 of the filling 40.2 of the running rail 9. The front sides 41.1, 41.2 are used to prevent tilting or clamping when the partial rail 38 is inserted into the running rail 9 and have a two-stage progression in the example described in FIG. 6. In the upper area of the front sides 41.1, 41.2, there is a steeper angle in the range of 60 to 70 degrees, in particular 65 degrees to the tread 43 of the running rail 9, whereby the movement of the partial rail 38, which is pre-centered by a not-shown pin guided in a corresponding recess, is slowed down as little as possible by friction between the front sides 41.1, 41.2. For damping and optimum power transmission between the partial rail 38 and the running rail 9, the front sides 41.1, 41.2 have a kink 53, from which the slope of the front sides 41.1, 41.2 are flatter in the lower area, in a range of 40 to 50 degrees, in particular at 45 degrees. In order to prevent the partial rail 38 from slipping out of the running rail 9 along the inclined interfaces 42.1, 42.2, 42.3 in the event of forces transmitted via the wheel 20 to the partial rail 38 by acceleration and/or braking operations of the shuttle 8, this is additionally secured against slipping in the direction of travel by a pin 46. The pin 46 is arranged in the running rail 9 and is immersed in a fastener 47 in the reinforcing element 39.1 of the partial rail 38 when connecting the partial rail 38 to the running rail 9. The partial rail 38, which is held in the running rail 9 only by the force of weight, is thus additionally secured against horizontal movement, i.e., in the direction of travel of the shuttle 8. Alternatively, a magnet, especially an electromagnet, can be installed instead of the pin 46, which additionally supports the weight force and further strengthens the protection against slipping.

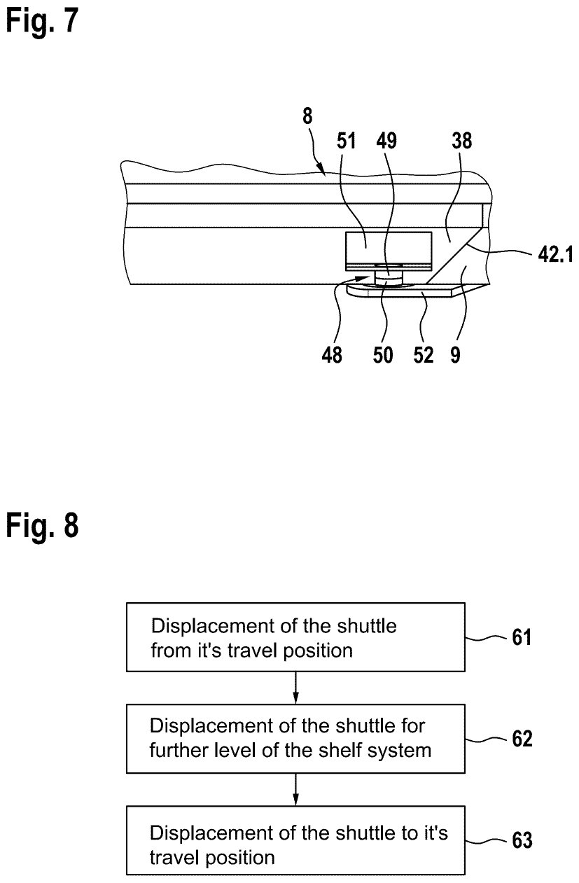

FIG. 7 shows a further detailed representation of the running rail 9, in which a plug 49 is used to electrically connect a conductor rail running in the partial rail 38 and in the running rail 9. The shuttle 8 is supplied with power via a conductor rail arranged on the running rail 9, which the shuttle 8 takes from the conductor rail via current collectors. When the partial rail 38 is removed, the electrical connection of the conductor rail must also be disconnected, or reconnected when inserted. This electrical separation is effected by means of a plug connection 48, wherein a plug 49 is connected to the partial rail 38 via an adapter 51 and a socket 50 is connected to the running rail 9 via an adapter 52.

FIG. 8 describes a possible method for moving a shuttle 8 with a shuttle elevator 30 from a level 21.x to a further level 21.x of a shelf system 1.

In a first method step 61, the shuttle 8 is displaced from its travel position.

In a second method step 62, the shuttle 8 is moved to a further level 21.x of the shelf system 1.

In a third method step 63, the shuttle 8 is displaced into its travel position.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A shuttle elevator for a shelf system, the shuttle elevator comprising:
at least one shuttle;
at least two levels for storing load carriers; and
a displacement unit.

2. The shuttle elevator according to claim 1, wherein the displacement unit is set up to displace the shuttle horizontally to a direction of travel of the shuttle.

3. The shuttle elevator according to claim 1, wherein the shuttle elevator is set up to lift the shuttle from its running rail.

4. The shuttle elevator according to claim 1, wherein the shuttle elevator is set up to lift a partial rail of a running rail of the shuttle with the shuttle arranged on this partial rail.

5. The shuttle elevator according to claim 4, wherein the displacement unit is set up to displace the partial rail of the running rail with the shuttle arranged on the partial rail.

6. The shuttle elevator according to claim 1, wherein the displacement unit comprises a lifting device.

7. The shuttle elevator according to claim 1, wherein the displacement unit comprises at least one locking mechanism.

8. The shuttle elevator according to claim 7, wherein the locking mechanism locks the shuttle, a displacement unit of the shuttle, and the partial rail.

9. A shelf system comprising the shuttle elevator according to claim 1.

10. The shelf system according to claim 9, wherein the shelf system comprises a running rail with a removable partial rail.

11. The shelf system according to claim 10, wherein the running rail comprises fasteners to mechanically connect the partial rail to the running rail.

12. The shelf system according to claim 11, wherein the fasteners are passively designed.

13. The shelf system according to claim 12, wherein the fasteners are actively designed.

14. The shelf system according to claim 10, wherein the running rail includes a plug connection to electrically connect the partial rail to the running rail.

15. The shelf system according to claim 9, wherein the shuttle elevator is arranged within a shelf for storing load carriers of the shelf system.

16. A method for moving a shuttle with a shuttle elevator from one level to a further level of a shelf system, the method comprising:
displacing the shuttle from a travel position;
displacing the shuttle to a further level of the shelf system; and
displacing the shuttle to the travel position.

17. The method according to claim 16, wherein the movement of the shuttle from its travel position includes a translational movement.

18. The method according to claim 16, wherein the movement of the shuttle from its travel position includes a rotational movement.

19. The method according to claim 16, wherein the movement of the shuttle from its travel position comprises two translational movements carried out substantially perpendicular to each other.

20. The method according to claim 16, wherein the movement of the shuttle to a further level of the shelf system is carried out within the shelf of the shelf system.

21. The method according to claim 16, wherein the movement of the shuttle into the travel position of the shuttle corresponds to the movements from the travel position in reverse order.
